(19) United States
(12) Patent Application Publication
(10) Pub. No.: US 2014/0335286 A1
(43) Pub. Date: Nov. 13, 2014

(54) LABEL PAPER PROCESSING METHOD AND APPARATUS

(71) Applicants: Hideo IZAWA, Narashino-shi (JP); Akira ISHIKAWA, Narashino-shi (JP); Reishi FUJIWARA, Daisen-city (JP)

(72) Inventors: Hideo IZAWA, Narashino-shi (JP); Akira ISHIKAWA, Narashino-shi (JP); Reishi FUJIWARA, Daisen-city (JP)

(73) Assignee: MIYAKOSHI PRINTING MACHINERY CO., LTD., Narashino-shi (JP)

(21) Appl. No.: 14/261,307

(22) Filed: Apr. 24, 2014

(30) Foreign Application Priority Data
May 10, 2013 (JP) 2013-099797

(51) Int. Cl. B31D 1/02

(52) U.S. Cl. CPC B31D 1/027; B31D 1/026
USPC 427/554; 118/37

(57) ABSTRACT

A label paper processing method includes printing a print image on label paper with a cutting locus along a contour of a shape to be cut out, using a printer in which the label paper is fed to travel intermittently. While the printed label paper is fed to travel continuously, it is half-cut with a laser beam irradiated along the printed cutting locus, thereby forming a half-cutout in the label paper. Operations of control and adjustments of a cutting depth are reduced, and a precisely cut label sheet is obtained without cutting the supporting sheet.

### TECHNICAL FIELD

The present invention relates to a label paper processing method and apparatus for printing an image on a label sheet of label paper and then half-cutting the label paper to form a cutout in the label sheet.

### BACKGROUND ART

A variety of label paper has hitherto been proposed in which label paper having a label sheet and a supporting sheet stuck together is printed on the label sheet with a print image and is half-cut to form a cutout in the label sheet on the supporting sheet and the cutout portion of the label sheet is peeled off the supporting sheet for use as a label or the like.

A processing method and apparatus in which such label paper is so printed on its label sheet and half-cut has been described in JP 2006-123431 A.

To wit, in a processing apparatus which comprises a printer having four printing units consecutively arranged in a path of intermittent paper travel and a cutting unit disposed downstream of the printer, there is described a processing method of printing label paper with an image on its label sheet in the printer and half-cutting the printed label paper in the cutting unit.

The cutting unit described in JP 2006-123431 A is comprised of a cutting roll having printed portion cutting edges and boundary cutting edges and an edge bearing roll in which rotating the cutting roll and the edge bearing roll appropriately in forward and backward feed of label paper allows the label paper to be half cut forming cutouts in the label sheet. Such cutting and edge bearing rolls are complicated to control in the cutting unit.

Moreover, the depth of cutting in the method is adjusted by increasing and decreasing the depth of cut minutely so that a cutting edge may not enter a supporting sheet and may not cut it, requiring techniques and periods of time, the adjustments are burdensome.

Furthermore, cutting by means of cutting edges renders it difficult to precisely cut a label sheet alone without cutting its supporting sheet, causing a deficient or excessive depth of cut and then giving rise to problems of a failure to paste and a burr or breakage with a post processing machine such as a labeler.

Also, use of cutting edges over a long period of time may deteriorate their sharpness in cutting and may further cause a cutout of label sheet to be stuck onto a cutting edge, entailing a time-consuming, costly cleaning and maintenance operation.

Made in order to resolve problems as mentioned above, the present invention has its object to provide a method of an apparatus for processing label paper whereby control operations in half-cutting the label paper and burdensome adjustments of a depth of cutting are reduced and it is made possible in half-cutting to precisely cut a label sheet alone without cutting its supporting sheet and further in which a time-consuming maintenance operation as mentioned above is made no longer necessary.

### DISCLOSURE OF THE INVENTION

In accordance with the present invention there is provided a method of processing label paper, characterized in that it comprises the steps of:

with a printer in which label paper is adapted to be fed to travel intermittently in a path of intermittent travel, printing the label paper with a print image and with a cutting locus along the contour of a shape to be cut out; and thereafter while the printed label paper is being fed to travel continuously in a path of continuous travel, half-cutting the printed label paper along the printed cutting locus with a laser beam irradiated so as to trace and scan the printed cutting locus, thereby forming a half-cutout of the shape in the label paper.

In a label paper processing method of the invention as mentioned above, the laser beam has an output and a diameter of its irradiation each fixed constant and a rate of its scanning controlled to set a cutting energy thereof so as to be commensurate with a thickness of a label sheet of the label paper.

A half-cut, cutout processing method is thus provided which is excellent in cut depth precision and which stabilizes the precession of cut depth and minimizes its variation, permitting a supporting sheet to be made thinner in thickness.

Also, where the output of the laser beam is fixed, its scanning rate can be made faster, permitting the label paper to be half cut while forming a cutout in the label sheet at an increased efficiency, thereby improving the productivity of labels.

In a label paper processing method of the invention as mentioned above, the cutting locus is printed continuously with a fixed width and in a black color identical in type to that in which the printing color is printed.

This eliminates the need to prepare an ink for exclusive use to print the cutting locus.

Also, printing the cutting locus in a black ink renders its print liable in laser cutting to absorb a laser beam processing energy, getting off with a less amount of processing energy to cut enough and hence reducing the cost of production of labels.

In a label paper processing method of the invention as mentioned above, the cutting locus has a width smaller than the diameter of irradiation of the laser beam.

By irradiating the cutting locus so printed with such a laser beam, the cutting locus is burned out over its entire widthwise area. Since the printed cutting locus is not left extant and disappears, the label paper cut out or a label is prevented from seeming unsightly due to the locus.

The present invention also provides an apparatus for processing label paper, comprising:

a paper supply means for continuously supplying label paper; a printer disposed downstream of the paper supply means and adapted for the label paper to be intermittently fed to travel therein for printing the label paper with a print image and with a cutting locus along a contour of a shape to be cut out; and

a laser processing means disposed in a path of continuous paper travel downstream of the printer for irradiating the label paper with a laser beam such as to trace and scan the printed cutting locus. Half-cutting label paper in continuous travel with the laser beam irradiated along the pre-printed cutting locus to form a cutout in accordance with the present invention advantageously reduces operations of control in half-cutting and burdensome cut depth adjustments as entailed in the prior art and it is made possible in half cutting to precisely cut a label sheet alone without cutting its supporting sheet.

Furthermore, since cutting is performed with the laser beam irradiated, a time-consuming maintenance operation as mentioned above is made no longer necessary.

### BRIEF DESCRIPTION OF THE DRAWINGS

In the Drawings:

FIG. 1 is a front view illustrating a label paper processing apparatus in a first form of implementation of the present invention;

FIG. 2 is a plan view of label paper printed with a print image and a cutting locus;

FIG. 3 is an explanatory view of a print image and a cutting locus; and

FIG. 4 is an explanatory view of a cutting locus that is printed in a region of the print image.

### BEST MODES FOR CARRYING OUT THE INVENTION

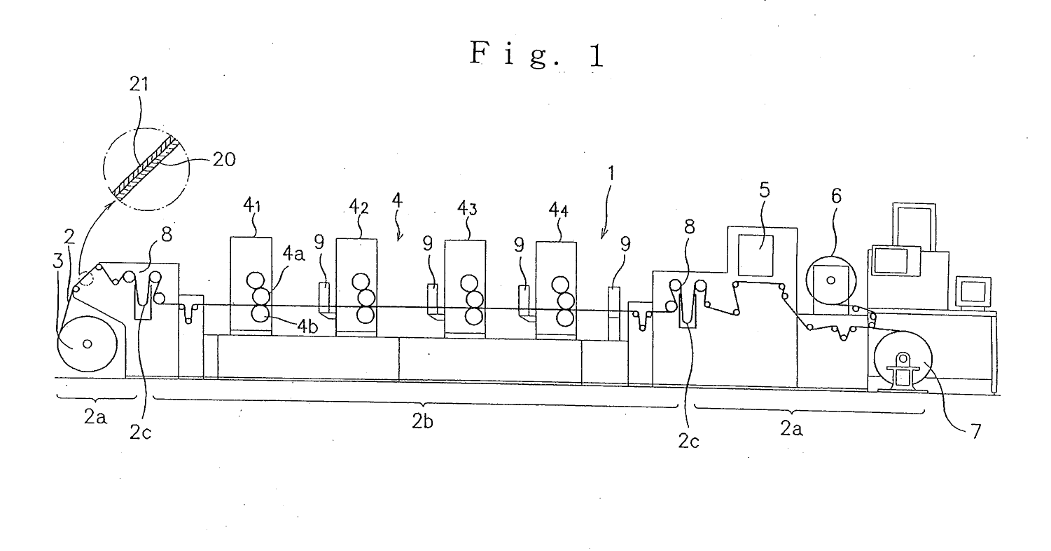

As shown in FIG. 1, a label paper processing apparatus 1 in the form of implementation of the present invention comprises a paper supply unit 3 for continuous supply of label paper 2, a printer 4 disposed downstream from the paper supply unit 3 for printing the label paper 2, a laser processing device 5 disposed downstream from the printer 4 for half-cutting the label paper 2, a waste removing device 6 disposed downstream from the laser processing device 5 and a paper take-up unit 7 disposed downstream of the waste removing device 6.

The label paper 2 is comprised of a supporting sheet 20 and a label sheet 21 which are stuck together. The label paper 2 is fed to travel continuously forwards in the paper supply unit 3, the laser processing device 5, the waste removing device 6 and the paper take-up unit 7, viz. in a path of continuous paper travel 2a in which the label paper 2 is allowed to continuously travel forwards. Meanwhile, the label paper 2 is fed to intermittently travel forwards and backwards in the printer 4, viz. in a path of intermittent paper travel 2b in which the label paper 2 is caused to travel intermittently.

Between the path of continuous travel 2a and the path of intermittent travel 2b there is provided a loop forming unit 8, two such units 8 being provided one upstream and the other downstream of the printer 4. In the loop forming unit 8, label paper 2 is temporarily stored in a loop 2c, whereby the label paper 2 is fed to travel intermittently forwards and backwards there while being fed to travel continuously forwards in the apparatus 1.

The paper supply unit 3 is adapted to continuously supply the label paper 2 from a roll thereof so that the label sheet 21 faces upwards.

The printer 4 here is a printer of intermittent paper feed type having a plurality of printing units, for example, a first, a second, a third and a fourth printing unit 4₁, 4₂, 4₃ and 4₄, arranged in order in the direction of travel of the label paper 2 and in which each of the printing units 4₁, 4₂, 4₃ and 4₄ is provided downstream with an ultraviolet dryer 9. In the printer 4, the label paper 2 is fed to travel forwards and backwards alternately over again to print on the label sheet 21 of the label paper 2. The label paper 2 after printing in each of the printing units is dried by its respective ultraviolet dryer 9.

In this form of implementation of the invention, a print image such as a character or characters and/or a figure or figures is printed on a surface of the label sheet 21 by each of the first, second and third printing units 4₁, 4₂ and 4₃ and a cutting locus along the contour of a shape to be cut out is printed on the surface of the label sheet 21 by the fourth cutting unit 4₄ (downstream-most printing unit).

Each of the first, second, third and fourth printing units 4₁, 4₂, 4₃ and 4₄ shown is a rotary press using a printing cylinder 4a and an impression cylinder 4b.

Note that each printing unit may also be a digital printer such as an ink jet printer or an electrophotographic printer.

The laser processing device 5 comprises a laser oscillator based on CO₂ or YAG for creating a laser beam, a laser beam amplifying means such as, for example, a beam expander, a means for condensing a laser beam with an optical lens, and one or more reflecting mirrors, wherein controlling the reflecting mirrors allows the focal length and the irradiation position of the laser beam to be varied as desired.

And, for half-cutting the label paper 2 by the laser processing device 5, a surface of the label sheet 21 of the label paper 2 fed to travel continuously in the path of continuous paper travel 2a is irradiated with a laser beam from the laser processing device 5.

The waste removing device 6 is provided whereby a waste of paper that remains as a part of the label sheet 21 after the label paper 2 is half-cut is peeled off the supporting sheet 20 and taken up.

The take-up unit 7 is provided to take up the label paper 2 having the waste of paper peeled off and removed.

Mention is next made of one embodiment of a method of processing label paper 2 according to the present invention.

Label paper 2 from the paper supply unit 3 is continuously supplied towards the printer 4 with the label sheet 21 facing upwards and the supporting sheet 20 lying downwards.

While being intermittently fed to travel forwards and backwards, the label paper 2 is printed with a print image on a surface of the label sheet 21 by each of the first, second and third printing units 4₁, 4₂ and 4a and thereafter on the surface of the label sheet 21 with a cutting locus by the printing unit 4₄.

Mention is next made of a specific embodiment of printing the cutting locus.

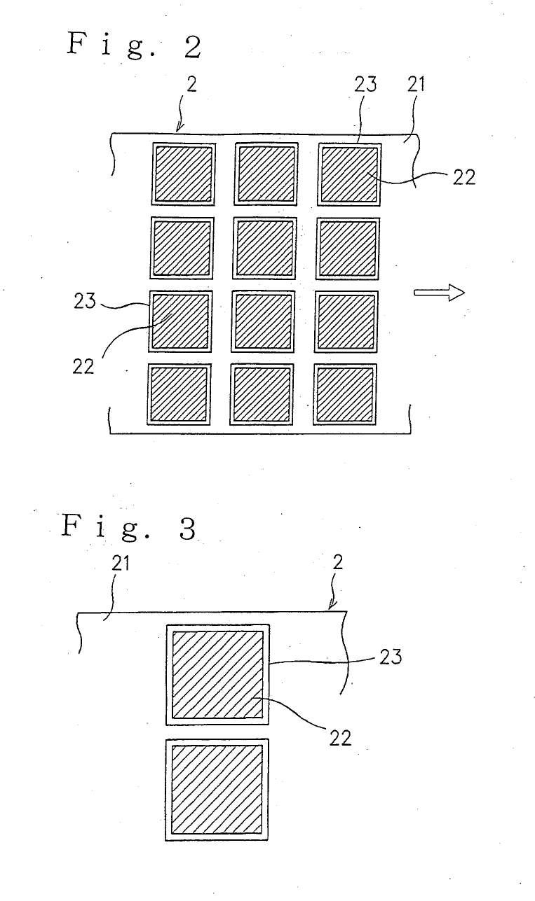

As shown in FIG. 2, after a surface of the label sheet 21 is printed with a print image 22 by each of the first, second and third printing units 4₁, 4₂ and 4₃, a surface area in which there is no printed image 22 (a blank or marginal area around the printed image 22) is printed with the cutting locus 23 by the printing unit 4₄ in a simple black color using an ink identical in type to that which is used to have the print image 22 printed.

The cutting locus 23 is that along the contour of a shape to be cut out.

While the label paper 2 having the print image 22 and the cutting locus 23 printed is being continuously fed to travel forwards, the label sheet 21 alone is cut by the laser processing device 5 and cut along the printed cutting locus 23 with the laser beam irradiated so as to trace or follow and scan the cutting locus 23.

To wit, the label paper 2 is half-cut with the laser beam irradiated along the printed cutting locus 23, thereby forming a cutout exclusively in the label sheet 21.

Half-cutting label paper 2 in continuous travel with the laser beam irradiated along the pre-printed cutting locus 23 to form a cutout in accordance with the present invention advantageously reduces operations of control in half-cutting and burdensome depth of cut adjustments as entailed in the prior art, sharply shortening the preparatory period of a half-cutting operation, and thereby improving the efficiency of production of labels.

Further, irradiation with a laser beam to cut yields a depth of cut in precision, giving rise to precise cutting of a label sheet 21 without cutting a supporting sheet 20.

Permitting the supporting sheet 20 thus to be made thinner allows reducing the amount of a waste (the supporting sheet 20 having the label sheet 20 peeled off), costing down the label paper 2.

To wit, the possibility of the conventional apparatus that a supporting sheet 20 can be cut through has so far required so thickening the supporting sheet 20 that it can no longer be cut through, this increasing the amount of the waste and costing up the label paper 2.

Further, cutting by irradiation with a laser beam renders it possible to ensure that the laser if used over an extended period of time is held to precisely cut a label sheet 21, and makes its maintenance the least time-consuming.

Mention is next made more specifically of cutting a label sheet 21 with a laser beam.

A depth of cutting effected by irradiating a surface of the label sheet 21 with the laser beam is determined by a processing energy of the laser beam and a color of a surface of the label sheet 21.

To wit, the larger or smaller the processing energy of a laser beam, the deeper or shallower the depth of cut. And, the darker or brighter the color of the surface of the label sheet 21, that is, the higher or lower the efficiency of absorption of the laser beam, the deeper or smaller shallower the depth of cut.

The laser beam has a processing energy determined by an output, a time period of irradiation and a density of irradiation of the laser beam. Thus, a processing energy of the laser beam can be adjusted by varying an output, a time period of irradiation and/or a density of irradiation of the laser beam.

The time period of irradiation is controlled by varying a scanning rate of the laser beam, and the density of irradiation of the laser beam is varied by varying an irradiation diameter, i.e. the diameter of a spot upon which the laser beam impinges on the processing surface.

In accordance with the present invention, a processing energy of the laser beam in half-cutting the label paper 2 to form a cutout therein is set so that cutting with the laser beam results in a depth of cut that becomes equal to a thickness of the label sheet 21. The label sheet 21 alone can thus be precisely cut without cutting the supporting sheet 20.

For example, with an output and a spot diameter each fixed of laser beam, its scanning rate is varied so as to set a processing energy of the laser beam such that the depth of cutting is equal to the thickness of the label sheet 21.

A half-cutting, cutout forming method is thus provided which is excellent in cut depth precision and which stabilizes precision of the cutting depth and minimizes its variation, permitting the supporting sheet 20 to be made thinner in thickness.

Also, where the output of a laser beam is fixed, its scanning rate can be made faster, permitting the label paper 2 to be half cut while forming a cutout in the label sheet 21 at an increased efficiency, thereby improving the productivity of labels.

The cutting locus 23 is printed continuously having its width unvaried.

The cutting locus 23 is printed having a width made smaller than a spot diameter of a laser beam. Note here that the spot diameter Φ is preferably from 0.2 mm to 0.3 mm.

By irradiating the cutting locus 23 so printed with such a laser beam, the cutting locus 23 is burned out over its entire widthwise area. Since its print is not left extant and disappears, the label paper 2 cut out or a label is prevented from seeming unsightly due to the locus.

Printing the cutting locus 23 in a black ink renders its print liable in laser cutting to absorb a laser beam processing energy, getting off with a less amount of processing energy to cut enough and hence reducing the cost of production of labels.

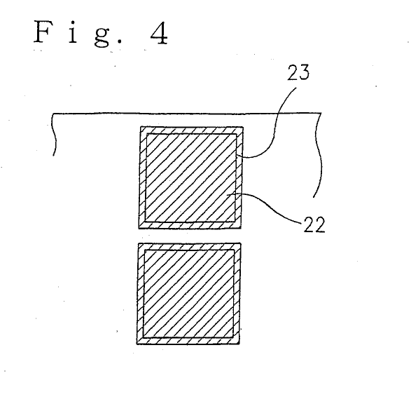

Moreover, whichever of the cutting locus 23 printed in an area in which there is no print image 22 as shown in FIG. 3 and the cutting locus 23 printed in an area of the print image 22 as shown in FIG. 4 can likewise be cut with a laser beam regardless of a background of the cutting locus.

The ink for use to print the cutting locus may be an ink which is identical in type to that for use to print a print image 22.

This eliminates the need to prepare an ink for exclusive use to print the cutting locus.

The laser processing apparatus 5 includes control units for controlling the output of the laser oscillator and the scanning rate of the laser beam, respectively.

And, in cutting along a straight or curved line of the locus, the output of the laser oscillator and the scanning rate of the laser beam are controlled while the scanning rate is being varied so as to be accelerated, to be uniform and to be decelerated from a starting point to an end point.

Also, a joint portion (such as a corner portion) of the locus is cut while controlling the output of the laser oscillator and the scanning rate of the laser beam so that a cut shape of the locus may be held with a given width and may not deteriorate in its quality.

1. A method of processing label paper, comprising:
with a printer in which label paper is adapted to be fed to travel intermittently in a path of intermittent travel, printing the label paper with a print image and a cutting locus along a contour of a shape to be cut out; and thereafter
while the printed label paper is being fed to travel continuously in a path of continuous travel, half-cutting the printed label paper along the printed cutting locus with a laser beam irradiated so as to trace and scan the printed cutting locus, thereby forming a half-cutout of said shape in the label paper.

2. The method of processing label paper as set forth in claim 1, wherein said laser beam has an output and a diameter of irradiation each fixed constant, and a rate of scanning is controlled to set a cutting energy thereof so as to be commensurate with a thickness of a label sheet of the label paper.

3. The method of processing label paper as set forth in claim 1, wherein said cutting locus is printed continuously with a fixed width and in a black color identical in type to a type in which a printing color is printed.

4. The method of processing label paper as set forth in claim 1, wherein said cutting locus has a width smaller than the diameter of irradiation of the laser beam.

5. An apparatus for processing label paper, comprising:
a paper supply unit which continuously supplies label paper;
a printer disposed downstream of the paper supply unit and adapted for the label paper to be intermittently fed to travel therein for printing the label paper with a print image and a cutting locus along a contour of a shape to be cut out; and
a laser processing unit which is disposed in a path of continuous paper travel downstream of said printer and which irradiates the label paper with a laser beam so as to trace and scan said printed cutting locus.

6. The method of processing label paper as set forth in claim 2, wherein said cutting locus is printed continuously with a fixed width and in a black color identical in type to a type in which a printing color is printed.

7. The method of processing label paper as set forth in claim 2, wherein said cutting locus has a width smaller than the diameter of irradiation of the laser beam.

8. The method of processing label paper as set forth in claim 3, wherein said cutting locus has a width smaller than the diameter of irradiation of the laser beam.

9. The method of processing label paper as set forth in claim 6, wherein said cutting locus has a width smaller than the diameter of irradiation of the laser beam.
